(19) United States
(12) Patent Application Publication
(10) Pub. No.: US 2007/0256365 A1
(43) Pub. Date: Nov. 8, 2007

(54) Temporary closure for insulation facing or vapor retarder and method of producing the temporary closure

(76) Inventor: Charles J. Petty, (US)

Correspondence Address: MCDONALD HOPKINS LLC, 600 Superior Avenue, East, Suite 2100, CLEVELAND, OH, 44114-2653, US

(21) Appl. No.: 11/787,133

(22) Filed: Apr. 13, 2007

Related U.S. Application Data
(60) Provisional application No. 60/791,681, filed on Apr. 13, 2006.
(60) Provisional application No. 60/875,763, filed on Dec. 18, 2006.

(51) Int. Cl. C09J 7/02

(52) U.S. Cl. 49/473

(57) ABSTRACT

An insulation apparatus is provided that may comprise an insulation member with an inner cavity and an elongated slit, a facing substantially covering the insulation member while permitting access to the slit, a closure member extending from the facing and traversing the slit to prevent access to the inner cavity in a temporarily closed position and a permanently closed position. An adhesive bead may be disposed on the inner surface of the closure member to secure the closure member to hold the closure member in a temporarily closed position, and an adhesive tape secured to the inner surface of the closure member capable of engaging the underlying facing during the permanently closed position.

### CROSS-REFERENCE TO RELATED APPLICATION

This application claims the benefit of priority of U.S. Provisional Patent Application Ser. No. 60/791,681, entitled: “Temporary Closure for Insulation Facing or Vapor Retarder,” filed on Apr. 13, 2006, and U.S. Provisional Patent Application Ser. No. 60/875,763, entitled: “Temporary Closure for Insulation Facing or Vapor Retarder and Method of Producing the Temporary Closure,” filed on Dec. 18, 2006, which are hereby incorporated in their entirety by reference.

### FIELD OF THE INVENTION

The present invention is generally related to an insulation apparatus, and more particularly to a temporary closure for use on insulation facing and/or vapor retarders and a method of producing the temporary closure.

### BACKGROUND OF THE INVENTION

Conventional pipes for transferring fluids such as refrigeration pipes, hot and cold water pipes, steam pipes, pipes for carrying petroleum products or chemicals, and the like, are commonly encased in insulation tubing. The insulation tubing typically is slit in the middle to form a hinged or clamshell configuration so that each portion may be placed around the pipe during installation. To further protect the insulation and/or to increase the effectiveness of the insulation, a protective insulation facing or vapor retarder is placed around the insulation and an overlapping seam or closure member, is provided for covering the exposed slit and sealing the pipe within the insulation.

Typically factory-applied facing is adhered to pipe insulation prior to installing the insulation around the pipe. Facings are typically fixedly adhered to insulation using multiple strips of hot-melt adhesive placed in various locations and patterns. For example, one may apply the adhesive in molten form by “guns” or nozzles that are parallel to the longitudinal axis of the insulation section and/or facing. These systems are typically set up to apply various numbers of strips in continuous or intermittent form onto the facing and/or the insulation section.

However, in order to later position a pipe within the portions of the insulation, known facings are fixedly adhered around only one of the slits of the insulation. Typically, the facing and insulation are permanently secured around the pipe by adhering the closure member to the facing with a strip of adhesive to form the closure. However, during transportation to the installation location these closure members require careful handling and special care. As can be appreciated, the insulation, closure member, and the underlying surface of these facings are frequently damaged or exposed to contamination. Damage to the insulation decreases the effectiveness of the insulation. Damage or contamination of the closure member and/or bonding surface can prevent proper bonding of the closure member and result in “fishmouthing” of the facing. Fishmouthing is a condition in which the protective wrap separates from the insulation thereby exposing the insulation and reducing its effectiveness.

Accordingly, attempts have been made to temporarily bond the closure member prior to shipment. Such attempts have typically focused on sandwich configurations wherein multiple layers of adhesives with varying degrees of holding strength are provided between the overlap and the bonding surface of the facing. However, such configurations are expensive and complex to manufacture. Additionally, such configurations require multiple steps to selectively remove adhesive layers in order to permanently seal the facing and insulation.

Therefore, a need exists for a temporary closure that will protect the insulation, closure member, and underlying bonding surface. Still further, a need exists for a temporary closure that can be quickly opened to expose the clamshell and install the pipe within the insulation. The present invention seeks to achieve these purposes in a simple, economical system that can be implemented with the use of the same or similar processes and materials currently used to fasten pipe insulation without a temporary closure.

Additional information will be set forth in the description which follows, and in part will be obvious from the description, or may be learned by practice of the invention.

### SUMMARY OF THE INVENTION

The present invention pertains to an insulation apparatus. In one embodiment an insulation apparatus may comprise an insulation member with an inner cavity and an elongated slit permitting access to the inner cavity, a facing substantially covering the insulation member while permitting access to the slit, a closure member extending from the facing and traversing the slit to prevent access to the inner cavity in a temporarily closed position and a permanently closed position. An adhesive bead may be disposed on the inner surface of the closure member to secure the closure member to either the underlying facing or the insulation member to hold the closure member in a temporarily closed position, and an adhesive tape secured to the inner surface of the closure member and adjacent the adhesive bead and capable of engaging the underlying facing during the permanently closed position.

### DESCRIPTION OF THE DRAWINGS

Operation of the invention may be better understood by reference to the following detailed description taken in connection with the following illustrations, wherein:

FIG. 1 is a diagrammatic end view of a facing having a temporary closure in an embodiment of the invention.

FIG. 2 is a perspective view of the installation of a pipe in an insulating member in an embodiment of the present invention.

FIG. 3 is a diagrammatic view of an unwound facing having a temporary closure in an embodiment of the present invention.

FIG. 4 is a diagrammatic end view of a facing having a temporary closure in an embodiment of the present invention.

FIG. 5 is a diagrammatic end view of a facing having a temporary closure in an embodiment of the present invention.

FIG. 6 is a diagrammatic view of an unwound facing having a temporary closure in an embodiment of the present invention.

FIG. 7 illustrates a diagrammatic end view of a facing having a temporary closure in an embodiment of the present invention.

FIG. 8 illustrates a method of producing a facing having a temporary closure in an embodiment of the present invention.

### DETAILED DESCRIPTION

While the present invention is described with reference to the embodiments described herein, it should be clear that the present invention should not be limited to such embodiments. Therefore, the description of-the embodiments herein is illustrative of the present invention and should not limit the scope of the invention as claimed.

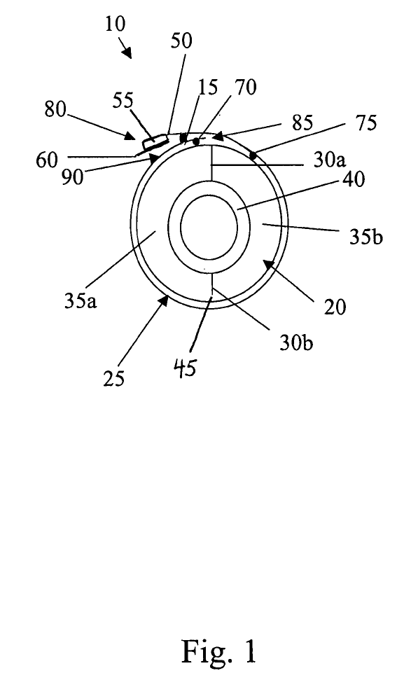

Reference will now be made in detail to the embodiments of the invention as illustrated in the accompanying figures. As shown in FIG. 1, the insulation apparatus with a temporary closure 10 generally comprises a closure member 50 having one or more adhesive beads 15 thereon. The adhesive bead 15 may be temporarily bonded to an insulation member 20 and/or a facing 25.

Insulation member 20 may be a pipe insulation, thermal barrier or the like. As best shown in FIG. 1, insulation member 20 is typically split 30a,b longitudinally into two substantially symmetrical segments 35a,b to facilitate installation around a pipe 40.

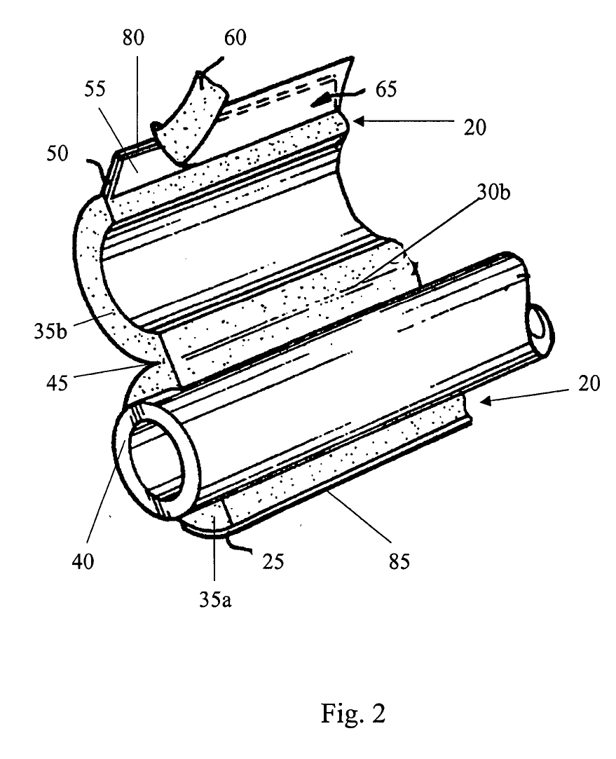

It is understood that insulation member 20 may be comprised of any material used to insulate a pipe, retain fluids, condensation and/or temperature of the fluids within the pipe. In one embodiment as shown in FIG. 2, the insulation member 20 may be a tubular fiberglass based body.

In one embodiment, the two symmetrical segments 35a,b may be joined along at least one common edge 45 by the facing 25, to form a clamshell configuration. In this manner, as shown in FIG. 2, the facing 25 acts like a hinge to allow the insulating member 20 to be fittingly engaged about the outside diameter of pipe 40. In addition, the facing 25 seals the hinged split 30b to maintain the insulating properties of the insulation system. In order to fully maintain the insulating integrity of insulation member 20, it is necessary to cover and seal the remaining longitudinal split 30a upon installation. Accordingly, as best shown in FIG. 1, the facing 25 is provided with an closure member 50 which may extend across the split 30a to engage the outer bonding surface 90 of the opposite longitudinal end 85 of the facing 25. It is understood that facing 25 may be any protective liner, such as an All Service Jacket. An illustrative example of an All Service Jacket is an aluminum foil/scrim/bleached paper product.

Generally, a double adhesive-sided tape 55 is positioned on the underside of closure member 50 as best shown in FIG. 2. The tape 55 may be any adhesive tape known to one of ordinary skill in the art. In a preferred embodiment, the tape 55 is self-seal lap (“SSL”) tape. The tape 55 may have a release liner 60 that is removeable to adhere the closure member 50 with the tape 55 to the bonding surface to form a permanent closure. The release liner 60 protects the tape 55 from damage and contamination until installation. In some embodiments as shown in FIG. 2, the release liner 60 may have a projection 65 that extends beyond the edge of the tape 55 to permit the user to conveniently remove the release liner 60 for permanently sealing the insulation member 20. It is understood that release liner 60 may be coated with a release coating, such as a silicone coating, in order to permit convenient removal of release liner 60. It is also understood that the present invention is not deemed as limited to only one piece of tape 25, and that any number of pieces of tape may be used.

A temporary closure 10 is utilized that may incorporate one or more adhesives, tapes and/or other adhering substances to temporarily secure the closure member 50 to the facing 25 and/or the insulation member 20 prior to the installation of the pipe 40. In one embodiment, the temporary closure 10 may have at least one adhesive bead 15, such as a hot melt adhesive bead. Although one adhesive bead 15 is shown in the illustrated embodiments, any number of such beads may be used as will be appreciated by one of ordinary skill in the art. Generally, the adhesive bead 15 extends longitudinally substantially the full length of the facing 25 and/or insulating body 20. However, it is also understood that the location and/or configuration of the adhesive bead 15 may be altered depending on the use of the facing 25. For example, the adhesive bead 15 may be one or more dots at any point along the facing 25 or a continuous or semi-continuous strip.

Additional adhesive beads, such as adhesive beads 70 and 75, may also be provided to fixedly secure the facing 25 to the insulation member 20. Adhesive beads 70 and 75 may extend substantially the entire length of the facing 25 in an amount sufficient to fixedly secure facing 25 to the insulation member 20. It is understood that adhesive beads 70 and 75 may be comprised of a different adhesive than adhesive bead 15 or with the same adhesive as adhesive bead 15. If the adhesive beads 15, 70, and 75 are the same type of adhesive, adhesive bead 15 is distinguished in that the amount applied to the facing 25 and/or insulation member 20 results in a weaker holding strength. Accordingly, when the closure member 50 is pulled, adhesive bead 15 releases while adhesive beads 70 and 75 maintain the bond between the insulation member 20 and facing 25. It is understood that in some embodiments additional adhesive beads may be used in a variety of positions and configurations to fixedly secure the facing 25 to the insulation body 20. It is also understood that in some embodiments, adhesive beads 70 and 75 may also be part of the temporary closure 10 and may be capable of detaching from either the facing 25 and/or insulation member 10 prior to installing the pipe 40.

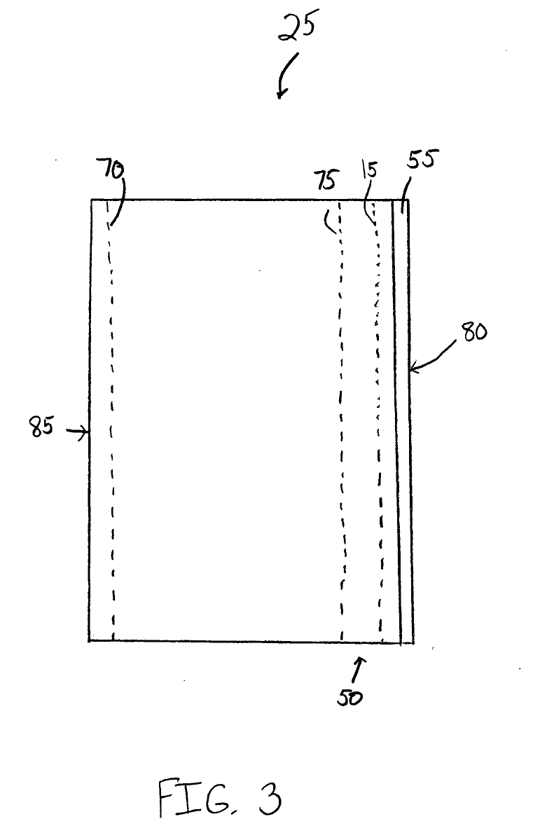

In a first embodiment shown in FIG. 1, the tape 55 with release liner 60 is positioned on the closure member 50 to permanently adhere the closure member 50 to the bonding surface 90. As best shown in FIG. 3 illustrating the interior surface of an unwound facing 25 without an insulating member 20, the tape 55 extends substantially along a longitudinal end 80 of the facing 25. Adhesive bead 15 is positioned inward from longitudinal end 80 and substantially adjacent to the tape 55. Adhesive bead 75 is positioned farther inward from longitudinal end 80 substantially adjacent to adhesive bead 15. Adhesive bead 70 is positioned substantially adjacent to longitudinal end 85. In an alternative embodiment (not shown), adhesive bead 15 may be positioned on the other side (outward facing surface) of the facing 25, substantially opposite of adhesive bead 70.

Referring again to FIG. 1, adhesive bead 70 fixedly secures the underlying surface of longitudinal end 85 to segment 35a, substantially adjacent to split 30a. Adhesive bead 75 fixedly secures the underlying surface of longitudinal end 80 to segment 35b, substantially adjacent to split 30a. Closure member 50 extends from adhesive bead 75 across split 30a to overlap part the outward bonding surface 90. Accordingly, adhesive bead 15 temporarily bonds closure member 50 to the outward surface of longitudinal end 85 adjacent the bonding surface 90.

As shown in FIG. 1, the temporary closure 10 may be opened with little or no damage to the outward surface of longitudinal end 85, where adhesive bead 15 is temporarily bonded. More importantly, no damage occurs to the bonding surface 90 that bonds with the tape 55 to form the closure that permanently seals the insulation. Accordingly, the temporary closure 10 protects the insulation member 20 and facing 25 without negatively impacting the performance of either.

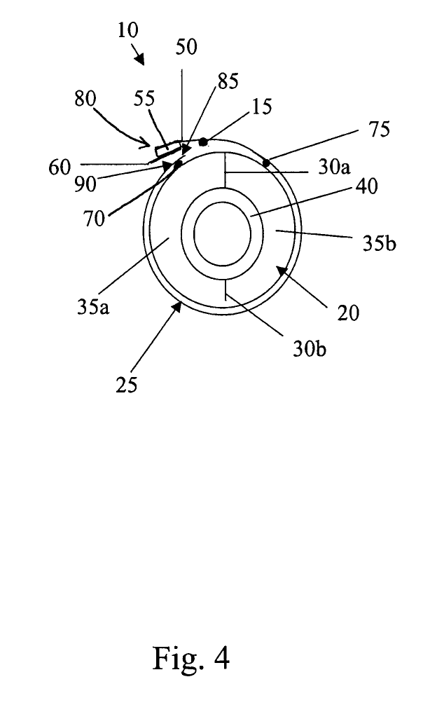

In an alternative embodiment shown in FIG. 4, the longitudinal end 85 is positioned sufficiently offset from slit 30a to allow adhesive bead 15 to temporarily bond to insulation segment 35a. The adhesive bead 15 is applied in a specific amount and/or configuration so that the bond will delaminate with minimal damage to the facing 25 or the surface of insulation segment 35a. It is preferred that insulation 35a delaminates slightly when the temporary closure 10 is opened, leaving adhesive bead 15 attached to closure member 50. Accordingly, when closure member 50 is permanently sealed with tape 55, any divot in insulation segment 35a resulting from the delamination will be refilled by adhesive bead 15. Therefore, the temporary closure 10 protects the insulation member 20 and facing 25 without negatively impacting the performance of either.

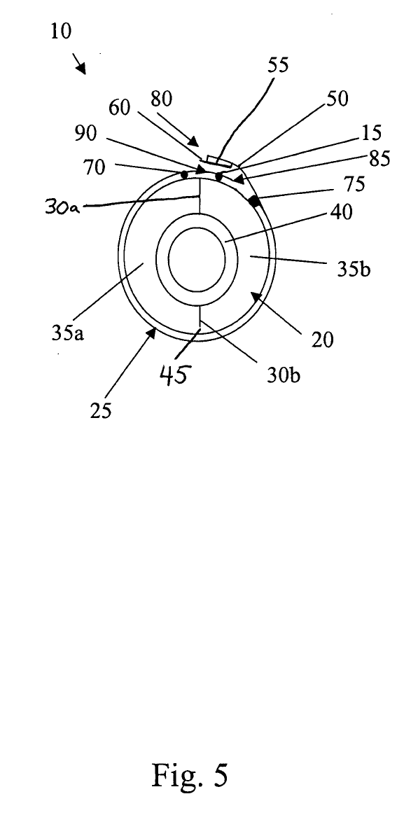

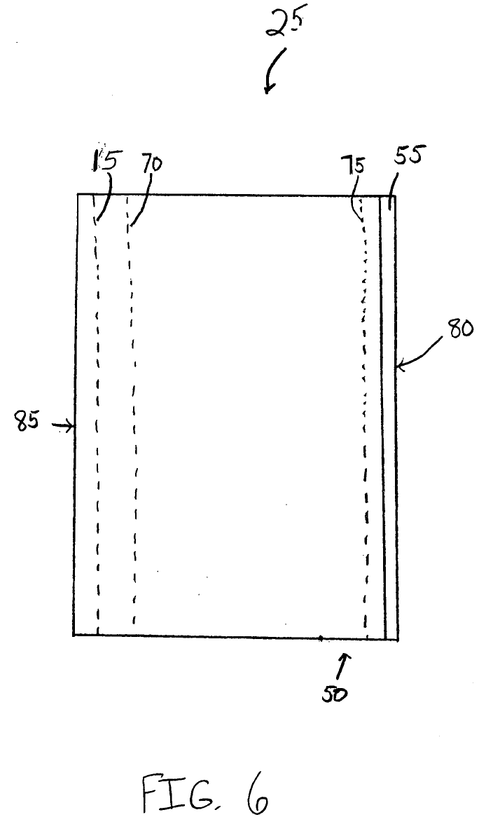

In yet another embodiment as shown in FIG. 5, facing 25 is positioned so that the underlying longitudinal end 85 spans the full slit 30a. As shown in FIG. 6 illustrating an unwound facing 25 without the insulating member 20, tape 55 is positioned substantially adjacent to longitudinal end 80. Adhesive bead 75 is positioned inward from longitudinal end 80 substantially adjacent to tape 55. Adhesive bead 15 is positioned substantially adjacent to longitudinal end 85 and adhesive bead 70 is positioned inward from longitudinal end 85 substantially adjacent to adhesive bead 15.

Referring again to FIG. 5, the positioning of temporary adhesive bead 15 allows adhesive bead 15 to temporarily bond to segment 35b, substantially adjacent to slit 30a. Adhesive bead 70 is fixedly bonded to segment 35a, substantially adjacent slit 30a. This configuration keeps insulation member 20 temporarily closed with adhesive bead 15 along longitudinal end 85, as opposed to along the closure member 50 in the other embodiments. Accordingly, positioning of adhesive bead 75 sufficiently adjacent to adhesive tape 55 prevents overlap seem 50 from freely opening to expose the bonding surface 90. However, closure member 55 remains flexible enough to access and pull underlying longitudinal end 85 to open the temporary closure 10. As similarly described above, it is preferred that insulation 35b delaminates slightly when the temporary closure 10 is opened, leaving adhesive bead 15 attached to underlying surface of longitudinal end 85. Accordingly, when closure member 50 is permanently sealed with tape 55, any divot in insulation segment 35b will be refilled by adhesive bead 15. Therefore, any damage to the facing 25 or insulation segment 35b will neither show nor be detrimental to the function of either the facing 25 or insulation member 20.

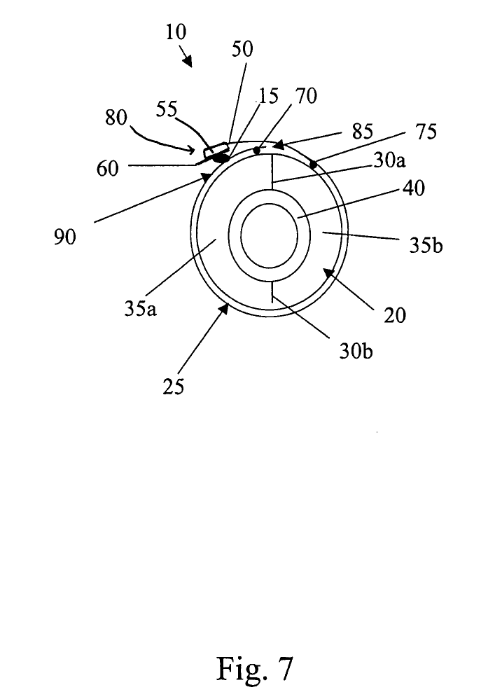

FIG. 7 illustrates yet another embodiment of the present invention. Adhesive beads 15, 70, and 75 are positioned similarly to FIG. 1. However, instead of being positioned adjacent to tape 55, adhesive bead 15 is positioned between the release liner 60 and the bonding surface 90. Accordingly, the adhesive bead 15 is applied in a specific amount and/or configuration so that the bond will delaminate with little or no damage to the bonding surface 90 when the temporary closure 10 is opened. Preferably, the adhesive bead 15 is retained on the release liner 60 and is subsequently removed with the release liner 60 prior to permanently sealing. Any damage to the bonding surface 90 is minimal and does not detract from the closure strength. When the tape 55 is applied, the adhesive fills any divots on the bonding surface 90 and permanently seals the insulation member 20 and facing 25.

In at least some embodiments, the tape 55 has a release liner 60 that protects tape 55 prior to installation, but also inhibits or prevents bonding to any type of adhesive. Accordingly, release liner 60 enables the tape 55 to be wound into rolls as supplied for use. In an embodiment, the tape 55 is SSL tape that is double-sided and, thus, prevents bonding to any adhesive, including adhesive bead 15. In such an embodiment, there are a number of solutions as will be appreciated by those of ordinary skill in the art. For example, an adhesive that specifically adheres to the release liner 60 and to the facing 25 may be used. In such an embodiment, the release liner 60 may be designed to accept a chosen adhesive, typically, but not necessarily, a hot melt type adhesive.

In yet another embodiment, a method is provided to solve the problem of adhering the adhesive bead 15 to the release liner 60. The method may comprise displacing or rendering ineffective at least a portion of the release liner 60 to which adhesive bead 15 will be applied. In one embodiment, a polyethylene coated kraft release liner 60 containing a layer of silicone is positioned on the tape 55. In such an embodiment, a hot bar, for example, may be dragged along or placed into contact with the release liner 60 to produce an area or band of exposed kraft fiber and/or bare polyethylene to which adhesive bead 15 can be applied. Adhesive bead 15 is then bondable to the release liner 60. An extending tab 65 may be provided to operate as an easy-lift tab to separate the release liner and adhesive bead from the tape 55 after opening of the temporary closure 10.

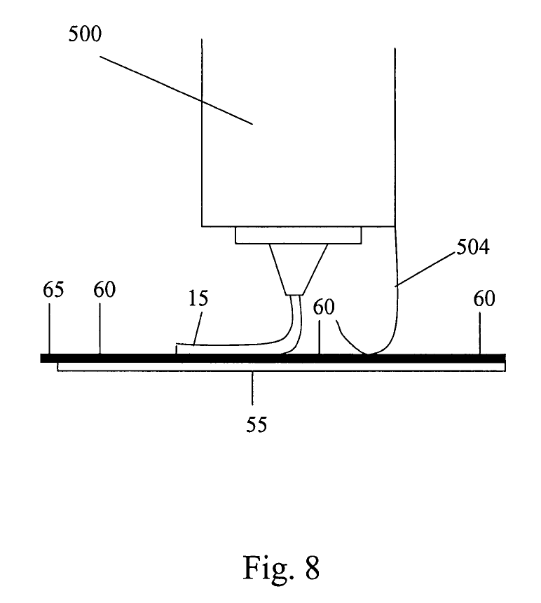

FIG. 8 illustrates a method of producing the temporary closure 10. A dispenser 500 provides and/or dispenses the adhesive bead 15 such as a hot melt adhesive. The release liner 60 receives the adhesive bead 15. A bar 504, such as aj-bar, contacts and or is dragged across the release liner 60. In an embodiment, the bar 504 may be heated to render the release coating ineffective. Other methods of altering and/or rendering the release coating ineffective are contemplated in the present invention. For example, a corona discharge, a flame treatment, a laser strike, an abrasion or the like may be applied to and/or implemented to render the release coating ineffective.

Regardless of the embodiment, the facing 25 and insulation member 20 with the temporary closure 10 are supplied as a unit from the factory or fabrication shop of the insulation maker. It is understood that although adhesive bead 15 may be described as a dot or a continuous or semi-continuous strip of adhesive, other patterns may be used. In one illustrative embodiment, a stitch pattern may be used. It is also understood that adhesive bead 15 may be applied at the same time as the adhesive beads (70, 75) used to bond the facing 25 to the insulation member 20 using the same or similar equipment. Other facing bonding systems, those primarily used in fabrication shops, may be able to use this as well. Additionally, the temporary closure 10, and more specifically adhesive bead 15 may be used in other applications such as vapor retarders, thermal barriers, or the like.

In addition, other adhesives may be used for adhesive bead 15. In one embodiment, adhesive bead 15 may be a pressure sensitive adhesive that is removable and repositionable without damaging the insulation member 20 or facing 25. For example, glues known in the art may be utilized for adhesive bead 15 that are applied wet but dry to have a tacky outer surface with a liquid glue interior. Accordingly, when the temporary closure 10 is opened and the permanent seal is applied, pressure may then be applied to adhesive bead 15 to release the still liquid adhesive allowing the adhesive bead 15 to re-adhere to the insulation member 20 or facing 25.

Turning to the temporary closure 10, an example of how to use the temporary closure 10 as shown in FIGS. 1-7 is set forth below. In use, the field installer removes the pipe insulation member 20 with facing 25 and temporary closure 10 in its form as illustrated in FIGS. 1, 4, and 5 from the box or container in which it was shipped to the job site. The installer merely breaks the temporary closure 10 formed by the adhesive bead 15 by manually pulling the closure member 50 with sufficient force to cause adhesive bead 15 to delaminate and allow the insulation member 20 to hingedly open as shown in FIG. 2. The installer can then slip the insulation member 20 over a pipe 40 by virtue of the hinge action as shown in FIG. 2. Up to this moment in time, the adhesive tape 55 remains covered by release liner 60. After the pipe insulation product has been slipped over pipe 40, the field installer peels away release liner 60 and presses the closure member 50 down onto the bonding surface 90. Accordingly, tape 55 bonds to the bonding surface 90 to form the closure that permanently seals the insulation member 20 and facing 25 around pipe 40.

The invention has been described above and, obviously, modifications and alternations will occur to others upon a reading and understanding of this specification. The claims as follows are intended to include all modifications and alterations insofar as they come within the scope of the claims or the equivalent thereof.

What is claimed is:

1. An insulation apparatus comprising:
an insulation member having an inner cavity;
an elongated slit in said insulation member permitting access to said inner cavity;
a facing substantially covering said insulation member while permitting access to said slit;
a closure member extending from said facing and traversing said slit to prevent access to said inner cavity in a temporarily closed position and a permanently closed position;
an adhesive bead disposed on the inner surface of said closure member to secure said closure member to either the underlying facing or said insulation member to hold said closure member in said temporarily closed position; and
an adhesive tape secured to the inner surface of said closure member and adjacent said adhesive bead and capable of engaging the underlying facing during said permanently closed position.

2. The insulation apparatus of claim 1 wherein said closure member is capable of being opened to break said adhesive bead connection to permit access to said insulation member inner cavity and permanently close said insulation member through engagement of said adhesive tape with the underlying facing.

3. The insulation apparatus of claim 1 wherein said adhesive bead is a continuous strip extending the longitudinal length of said closure member.

4. The insulation apparatus of claim 1 further comprising a protective release liner removably adhered on said adhesive tape.

5. The insulation apparatus of claim 1 wherein said facing forms a living hinge to allow said inner surface of said insulation member to be fitted around a pipe.

6. The insulation apparatus of claim 1 wherein said adhesive tape is positioned substantially along the edge of said closure member.

7. The insulation apparatus of claim 1 wherein said adhesive bead is a hot melt adhesive.

8. The insulation apparatus of claim 1 wherein said adhesive tape is a self-seal lap tape.

9. The insulation apparatus of claim 1 wherein said insulation member comprises two semi-cylindrical segments.

10. The insulation apparatus of claim 1 wherein said insulation member is a fiberglass material.
